(19) United States
(12) Patent Application Publication
(10) Pub. No.: US 2005/0060441 A1
(43) Pub. Date: Mar. 17, 2005

(54) Multi-use data access descriptor

(76) Inventor: Mark A. Schmisseur, Phoenix, AZ (US)

Correspondence Address: INTEL CORPORATION, P.O. BOX 5326, SANTA CLARA, CA, 95056-5326, US

(21) Appl. No.: 10/882,377

(22) Filed: Jun. 30, 2004

Related U.S. Application Data
(63) Continuation-in-part of application No. 09/820,121, filed on Mar. 27, 2001, now abandoned.

(51) Int. Cl. G06F 13/28

(52) U.S. Cl. 710/22

(57) ABSTRACT

Described are a system and method of processing data access descriptors. One or more data fields in a data access descriptor may be selectively processed as information identifying a memory location of a contiguous data buffer or information identifying a memory location of a scatter gather list based upon information in a control data field of the data access descriptor.

### PRIORITY INFORMATION

This application is a continuation-in-part of application Ser. No. 09/820,121, filed Mar. 27, 2001, and claims the benefit of priority thereof.

### BACKGROUND

1. Field

The subject matter disclosed herein relates to systems for accessing data stored in memory devices. In particular, the subject matter disclosed herein relates to the transmission of data stored in a memory device through a data bus.

2. Information

With the increasing speed of processing technology, intelligent input/output (I/O) systems have provided programmable systems for controlling access to I/O subsystems such as redundant arrays of independent disks (RAID), small computer system interface (SCSI), communication ports and the like. With programmable logic, an intelligent I/O system in a processing platform may enable the offloading of low level I/O tasks from an operating system of host processing system in the processing platform.

An intelligent I/O system typically comprises logic for controlling one or more direct memory access (DMA) channels to initiate bus transactions on one or more data busses in a processing platform. I/O subsystems are typically configured as bus agents and the DMA channels process descriptors to transfer data to or from the I/O subsystems. Such descriptors may be stored in a memory local to the intelligent I/O system and then sequentially processed to execute I/O requests from a host processing system.

I/O requests from a host processing system may be in the form of multiple formats. An intelligent I/O system may then format corresponding descriptors in the local memory to be processed by one or more DMA channels to meet the I/O requests. This formatting of the descriptors may impose processing overhead on the intelligent I/O system.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic diagram of a processing system according to an embodiment of the present invention.

FIG. 2 shows a schematic diagram of a data access descriptor according to an embodiment of the present invention.

FIG. 3 shows a schematic diagram of a scatter gather list according to an embodiment of the present invention.

FIG. 4 shows a schematic diagram of a processing system according to an alternative embodiment of the present invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relate to expressions which may be understood by one or more machines for performing one or more logical operations. For example, machine-readable instructions may comprise instructions which are interpretable by a processor compiler for executing one or more operations one or more data objects. However, this is merely an example of machine-readable instructions and embodiments of the present invention are not limited in this respect.

“Machine-readable medium” as referred to herein relates to media capable of maintaining expressions which are perceivable by one or more machines. For example, a machine readable medium may comprise one or more storage devices for storing machine-readable instructions. However, this is merely an example of a machine-readable medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Also, logic may comprise processing circuitry in combination with machine-executable instructions stored in a memory. However, these are merely examples of structures which may provide logic and embodiments of the present invention are not limited in these respects.

A “processing system” as discussed herein relates to a combination of hardware and software resources for accomplishing computational tasks. For example, a processing system may comprise one or more processors to execute machine-readable instructions stored in a machine-readable medium. However, this is merely an example of a processing system and embodiments of the present invention are not limited in this respect. A “host processing system” relates to a processing system which may be adapted to communicate with a “peripheral device.” For example, a peripheral device may provide inputs to or receive outputs from an application process hosted on the host processing system. However, these are merely examples of a host processing system and peripheral device, and embodiments of the present invention are not limited in these respects.

A “data bus” as referred to herein relates to circuitry for transmitting data between devices. For example, a data bus may transmit data between devices in a processing platform comprising a host processing system and one or more peripheral devices. However, this is merely an example of a data bus and embodiments of the present invention are not limited in this respect. A “bus transaction” as referred to herein relates to an interaction between devices coupled in a bus structure. For example, a bus transaction may comprise the transmission of data between or among devices according to addresses associated with the devices. However, this is merely an example of a bus transaction and embodiments of the present invention are not limited in this respect.

A “bus agent” as referred to herein relates to an entity which is addressable through a data bus. Such a bus agent may be associated with a particular device coupled to a data bus, or a particular function defined by such a device. In some embodiments, a processing system may execute a bus enumeration process to be configured to communicate with one or more bus agents. However, these are merely examples of a bus agent and embodiments of the present invention are not limited in these respects.

A “buffer” or “data buffer” as referred to herein relates to a portion of a memory in which data may be temporarily stored and then retrieved. Such a data buffer may be defined by an address and a data size. However, this is merely an example of a data buffer and embodiments of the present invention are not limited in this respect. A “contiguous data buffer” as referred to herein relates to a data buffer in a contiguous portion of memory such that the entire contiguous data buffer may be accessed by a single address and a data size. A “non-contiguous data buffer” as referred to herein relates to a data buffer comprising segments stored in more than one memory location. Such a non-contiguous data buffer may be defined by multiple memory addresses, one memory address for each segment. However, these are merely examples of contiguous and non-contiguous data buffers, and embodiments of the present invention are not limited in these respects.

A “shared memory” as referred to herein relates to a portion of memory which is accessible by more than one device. A shared memory may be accessible by multiple processing systems or devices in a processing platform. For example, a processing system may store data in a shared memory which is to be processed by device having access to the shared memory. However, these are merely examples of a shared memory and embodiments of the present invention are not limited in these respects.

A data bus may transfer data between devices or bus agents in a processing platform using a “direct memory access” (DMA) through which data may be transferred in the data bus independently of one or more processes hosted on a host processing system. For example, a device coupled to a data bus structure may act as a bus master to initiate bus transactions to store or retrieve data in memory associated with bus agents. However, these are merely examples of DMA systems and embodiments of the present invention are not limited in these respects.

A “transaction descriptor” as referred to herein relates to a data structure comprising information which may be processed by logic to execute one or more transactions in a processing system. Such a transaction descriptor may comprise a “data access descriptor” which relates to a data structure comprising information identifying a data source from which data is to be accessed. Such a data access descriptor may specify a memory address (either physical or logical memory address) as a data source. Such a data access descriptor may also comprise data indicating a data size of a portion of memory to be accessed at the source memory address. For example, a data access descriptor may identify a memory location storing an associated data buffer (e.g., beginning memory address of buffer and size of buffer). Also, a data access descriptor may also specify a memory address as a destination address for any retrieved data buffers. However, these are merely examples of a data access descriptor and embodiments of the present invention are not limited in this respect.

A “scatter gather list” as referred to herein relates to a data structure comprising two or more data items for one or more transactions involving the access of two or more segments of a non-contiguous data buffer from a memory. For example, a scatter gather list may comprise a data item specifying a memory address and data size for each non-contiguous segment to be accessed. Also, a scatter gather list may comprise data specifying a destination (e.g., a logical or physical memory address) for storage of any accessed non-contiguous data buffers in a contiguous data buffer. However, these are merely examples of a scatter gather list and embodiments of the present invention are not limited in these respects.

Briefly, an embodiment of the present invention relates to a system and method of processing data access descriptors. One or more data fields in a data access descriptor may be selectively processed as one of information identifying a memory location of a contiguous data buffer and information identifying a memory location of a scatter gather list based upon information in a control data field of the data access descriptor. However, this is merely an example embodiment of the present invention and other embodiments of the present invention are not limited in these respects.

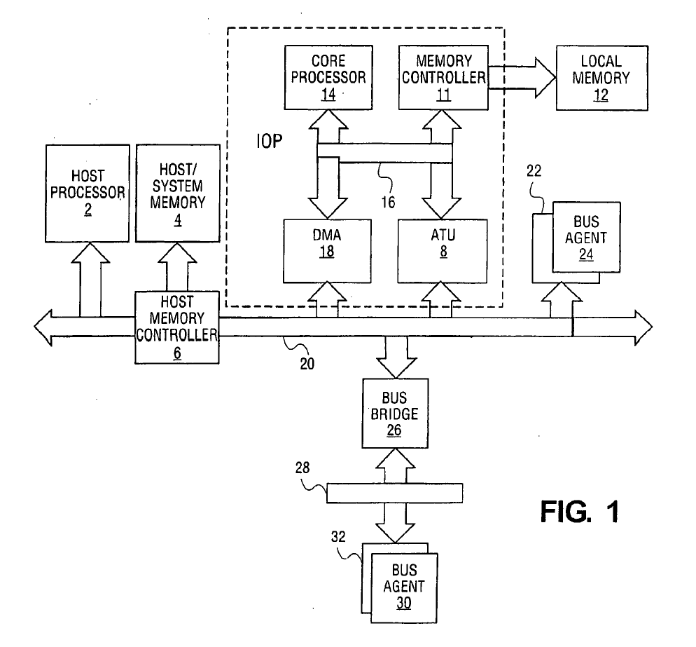

FIG. 1 shows a schematic diagram of a processing platform according to an embodiment of the present invention. A processor 14, memory controller 11 and DMA channel 18 are coupled to a common internal bus 16. The internal bus 16 may comprise a data bus formed according to any one of several data bus architectures such as, for example, Peripheral Components Interconnect (PCI) data bus as provided in the PCI Local Bus Specification Rev. 2.2, PCI-X as provided in the PCI-X Specification Rev. 1.0a, the HyperTransport™ bus architecture promoted by Advanced Micro Devices or the Advanced Microcontroller Bus Architecture (AMBA). However, these are merely examples of bus architectures which may be used for a data bus and other suitable data bus architectures may be used. The local memory 12 may comprise any combination of volatile and non-volatile memory including, for example, RAM, flash memory or a hard disk, and may define one or more addressable data buffers which are accessible by processes hosted on the processor 14 and the DMA channel 18 through the memory controller 11. However, this is merely an example of a processing platform which may be used in accordance with embodiments of the present invention and other embodiments are not limited in these respects.

The DMA channel 18 may be coupled to a bus 20 to initiate bus transactions between or among bus agents. A bridge 26 may define the bus 20 as a “primary” bus and define the bus 28 as a “secondary” bus (e.g., treating the processor 14 and system memory 12 as part of a host processing system). Alternatively, the bridge 26 may define the bus 20 as a secondary bus and define the bus 28 as a primary bus (e.g., treating the DMA channel, system memory 12 and processor 14 as a peripheral device to a host processing system (not shown) coupled to the bridge 26 through the bus 28). The busses 20 and 28, and bridge 26 may be formed according to any one of several data bus architectures such as, for example, Peripheral Components Interconnect (PCI) data bus as provided in the PCI Local Bus Specification Rev. 2.2, PCI-X as provided in the PCI-X Specification Rev. 1.0a, the HyperTransport™ bus architecture promoted by Advanced Micro Devices or AMBA. However, these are merely examples of how a bridge may relate to a peripheral device or host processing system and embodiments of the present invention are not limited in this respect.

The DMA channel 18 is coupled to one or more bus agents 22, 24, 30 and 32 through the data bus 20. The DMA channel 18 may communicate with bus agents 30 and 32 through a bridge 26. The bus agents 22, 24, 30 or 32 may be associated with any one of several devices or I/O subsystems such as, for example, a RAID system, SCSI interface or communication ports. The bus agents 22, 24, 30 or 32 may also access data stored in addressable memories which may be accessed in a DMA transaction initiated by the DMA channel 18. However, these are merely examples of bus agents which may communicate with a DMA channel and embodiments of the present invention are not limited in these respects.

According to an embodiment, the DMA channel 18 comprises logic to initiate DMA transactions among two or more of the bus agents 22, 24, 30 and 32. In another embodiment, the DMA channel 18 may initiate DMA transactions between the host memory 4, and the local memory 12, or between the local memory 12 and one or more of the bus agents 22, 24, 30 and 32. Such DMA transactions may be initiated as described in the Intel® 80303 I/O Processor Developer's Manual, Section 19, Intel Corporation, June 2000. However, these are merely examples of how a DMA channel may interact with one or more bus agents or memories in a processing platform and embodiments of the present invention are not limited in these respects.

According to an embodiment, the DMA channel 18 may comprise logic to initiate a DMA transaction to transmit the contents of a contiguous data buffer at an addressable memory location associated with a first bus agent to an addressable memory location associated with a second bus agent. In the illustrated embodiment, a shared portion of the local memory 12 may maintain data access descriptors identifying DMA transactions to be performed by the DMA channel 18. The shared portion of the local memory 12 may then store the data access descriptors which are accessible by the DMA channel 18 and processes hosted on the processor 14. Accordingly, the processor 14 may write data access descriptors in the shared memory portion and the DMA channel 18 may retrieve such data access descriptors for processing. Such descriptors may be stored in the local memory 12 as a chain of descriptors in a linked-list data structure where the DMA channel 18 may process each descriptor in a chain of descriptors is sequentially received from an addressable memory until the last descriptor is processed. Such chain descriptors may be as described in the Intel® 80303 I/O Processor Developer's Manual, Section 19.3.1 Intel Corporation, June 2000. In an alternative embodiment, the data access descriptors may be stored in the shared portion of local memory 12 in a continuous ring buffer. However, these are merely examples of how a shared memory may store descriptors to be processed by a DMA channel and embodiments of the present invention are not limited in these respects.

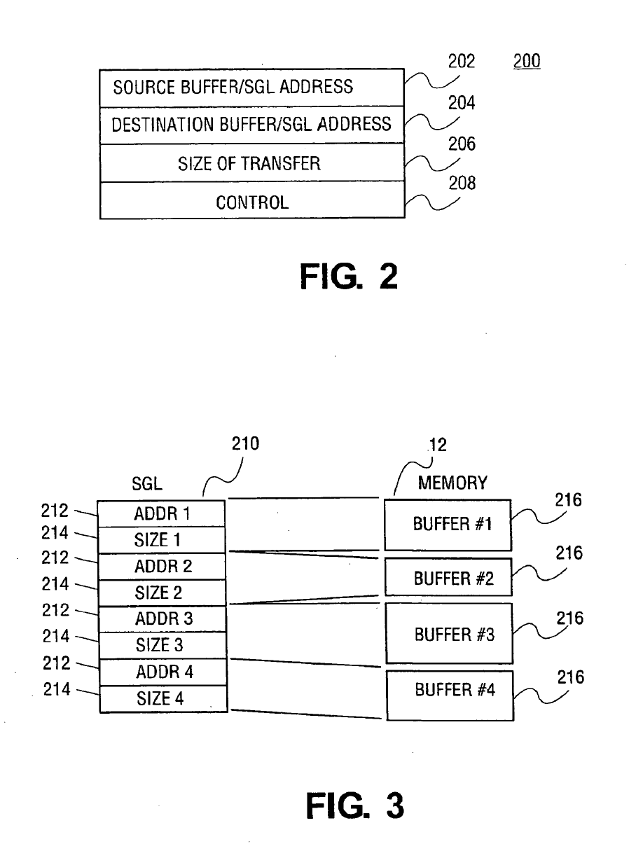

FIG. 2 shows a schematic diagram of a data access descriptor 200. The data access descriptor may be stored in the local memory 12 and processed by the DMA channel 18 (FIG. 1). The data access descriptor 200 may also comprise four fields: addressing fields 202 and 204; size field 206 and control field 208. However, this is merely an example format of a data access descriptor and embodiments of the present invention are not limited in this respect.

In the illustrated embodiment, data in the control field 208 indicates whether the data access descriptor 200 is to be processed as a DMA descriptor for the transfer of a contiguous data buffer, or whether the data access descriptor 200 indicates a memory location of a scatter gather list for processing. For example, one or more bits in the control field 208 may indicate that the data access descriptor 200 is to be processed as a DMA descriptor for the transfer of a contiguous data buffer located at a “source buffer” address stored in field 202 to a “destination buffer” address stored in field 204. Field 206 indicates the size of the contiguous data buffer to be retrieved and transferred. In a processing system according to the embodiment of FIG. 1, for example, the DMA channel 18 may process the data access descriptor 200 as a DMA descriptor for the transfer of a contiguous data buffer located at a source buffer address associated with a first bus agent to a destination address associated with a second bus agent.

The control field 208 may also comprise one or more bits indicating that the data access descriptor 200 is to represent a location of a scatter gather list to be processed beginning at a “scatter gather list address” stored in one or more of the data fields 202 and 204, and represent the size of the scatter gather list at field 206. In a processing system according to the embodiment of FIG. 1, for example, the DMA channel 18 may process the data access descriptor 200 to retrieve a scatter gather list from a memory associated with a bus agent or from the local memory 12. The location of the scatter gather list may be indicated at an addressable location represented in one or more of the fields 202 and 204. The DMA channel 18 may then process the retrieved scatter gather list to initiate one or more bus transactions to transfer data stored at locations indicated in the scatter gather list.

In the embodiment illustrated with reference to FIG. 1, the DMA channel 18 may comprise logic to selectively process data fields of a data access descriptor as either information identifying a memory location of a contiguous data buffer or information identifying a memory location of a scatter gather list based upon information in a control data field of the data access descriptor. Since bits stored in the control field 208 may indicate that the fields 202, 204 and 206 are to represent either information to initiate a DMA transfer of a contiguous buffer or the location and size of a scatter gather list, the DMA channel 18 may receive data access descriptors for either transaction in a common format. However, this is merely an example of how a DMA channel may process data access descriptors in a common format to represent either information to initiate a DMA transfer of a contiguous buffer or the location of a scatter gather list, and embodiments of the present invention are not limited in this respect.

The DMA channel 18 may process a data access descriptor representing a location of a scatter gather list by retrieving the scatter gather list, and processing the scatter gather list to initiate the transfer segments of a non-contiguous data buffer identified in the scatter gather list. The DMA channel 18 may comprise logic to initiate multiple DMA transactions to transfer each of the segments of the non-contiguous data buffer among bus agents. By enabling the DMA channel 18 to process data access descriptors for the initiation of a DMA transfer of a contiguous data buffer or the processing of a scatter gather list, the processor 14 need not process scatter gather lists to generate multiple data access descriptors to be processed by the DMA channel 18.

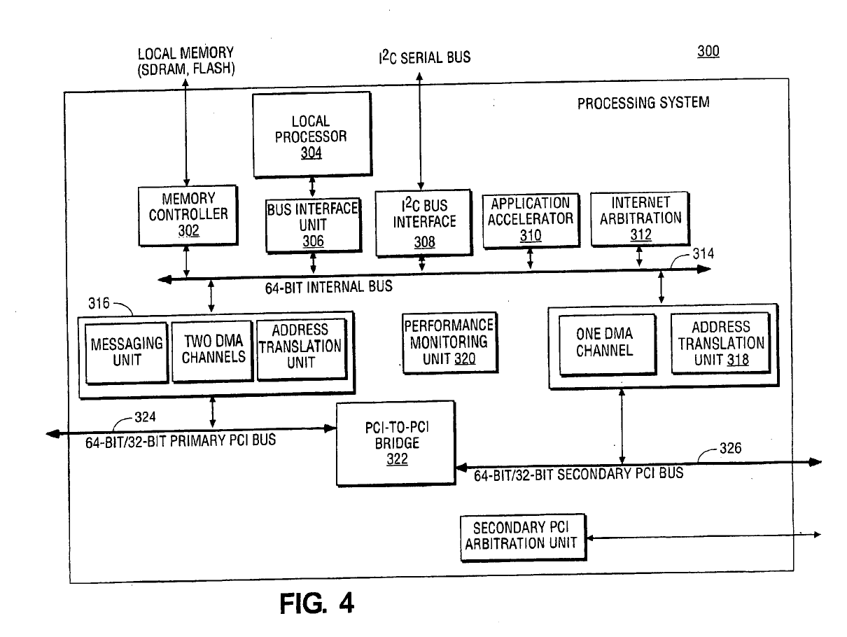

FIG. 3 shows a schematic diagram of a scatter gather list according to an embodiment of the present invention. A scatter gather list 210 may be stored in a memory accessible through a bus agent by a DMA channel (such as the DMA channel 18 in the embodiment of FIG. 1). For example, such a scatter gather list may be stored in the local memory 12 or in a memory accessible through one of the bus agents 22, 24, 30 or 32. Also, the scatter gather list 210 may be referenced by information in data access descriptor such as an embodiment of the data access descriptor 200 shown in FIG. 2.

According to an embodiment, the scatter gather list 210 comprises a plurality of address fields 212 interleaved with corresponding size fields 214 to identify the locations of segments 216 of a non-contiguous data buffer. Each corresponding pair of address field 212 and size field 214 represents the size and location of a corresponding segment 216. In another embodiment, the scatter gather list 210 may also comprise information indicating a destination for the segments 216. In the embodiment shown in FIG. 1, such a destination address may be associated with one or more of the bus agents 22, 24, 30 or 32. In one embodiment, the scatter gather list 210 may indicate a single destination address to store the segments 216 as a contiguous data buffer. Alternatively, the scatter gather list may indicate a destination address for each of the segments to transfer the retrieved segments 216 as a non-contiguous data buffer. However, this is merely an example of a scatter gather list and embodiments of the present invention are not limited in this respect.

In an alternative embodiment, a DMA channel may access a scatter gather list in a page list format, as illustrated in FIG. 5, in which buffer addresses may be provided without size information, as each buffer is assumed to be of equal size. The size of each buffer may be programmed into the control field 208 of the descriptor 200, into the DMA channel 18, or may be known to be of a fixed size. Furthermore, in page list format, the first and last buffers may not be full pages. This may be supported if the size of the transfer is less than the total size of the buffers needed to store the data, where the addresses may be aligned (i.e., each address starts at the beginning boundary of the buffer), or unaligned (i.e., each addresses starts within, but not including, the beginning boundary of the buffer). For example, if the size of the transfer is 9KB, and the size of each buffer is 4KB, the page list may comprise 3 addresses: ADDR1 may point to 4KB of data starting at the beginning boundary, ADDR2 may point to the next 4KB of data starting at the beginning boundary, and ADDR3 may point to the last 1KB of data starting at the beginning boundary. In this case, the last buffer may not be a full page. Using the same example above, the addresses may be aligned differently. For example: ADDR1 may point to 3KB of data starting within the beginning boundary of the 4KB buffer; ADDR2 and ADDR3 may each point to the next 4KB of data, respectively, starting at the beginning boundary of the 4KB buffer; and ADDR4 may point to the last 2KB of data starting at the beginning boundary of the 4KB buffer. In this case, the first buffer may not be a full page.

In yet another embodiment, multiple scatter gather list formats may be supported. A scatter gather list format refers to an arrangement of data in a scatter gather list. In one embodiment, control field 208 may additionally and/or alternatively comprise one or more bits indicating one of multiple scatter gather list formats. For example, a scatter gather list format may comprise a format list as illustrated in FIG. 3 (e.g., to indicate a contiguous data buffer or a non-contiguous data buffer as discussed above). A scatter gather list format may alternatively comprise a page list as illustrated in FIG. 5. Of course, other formats are possible, and may be indicated by control field 208. Again, these are merely examples of scatter gather lists and embodiments of the present invention are not limited in these respects.

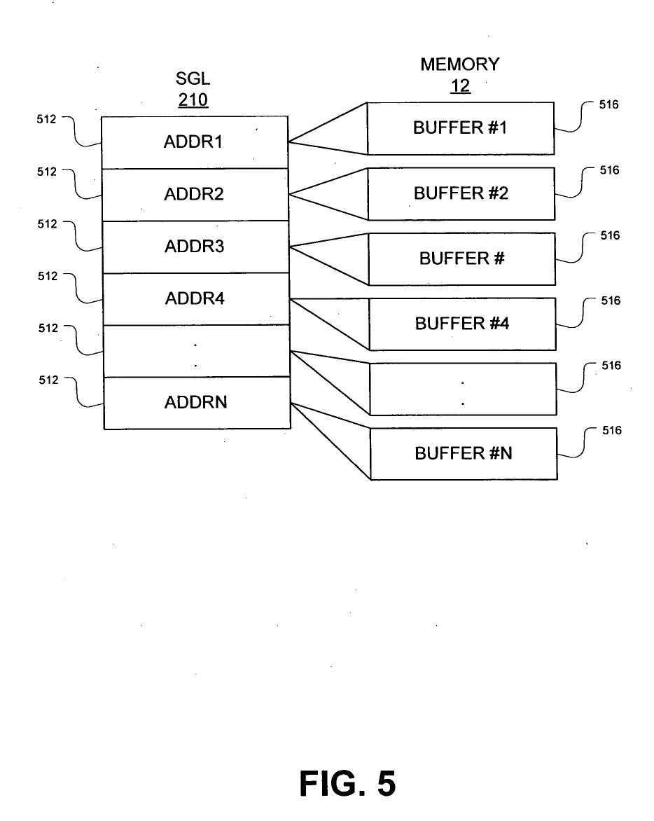

FIG. 4 shows a schematic diagram of a processing system 300 according to an alternative embodiment of the present invention comprising more than one DMA channel. A PCI-to-PCI bridge 322 is coupled to a host processing system (not shown) through a primary bus 324 and is coupled to bus agents (not shown) through a secondary bus 326. An internal bus 314 is coupled to a system memory through a memory controller 302, a local processor 304, a first DMA channel 316 and a second DMA channel 318. Each of the DMA channels 316 and 318 may access portions of the system memory which are also accessible by the local processor 304 and external bus agents on the primary and secondary PCI busses via address translation units 316 and 318. Here, the local processor 304 may write data access descriptors to these portions of the system memory to be processed by the DMA channels 316 and 318. Such data access descriptors may have a common format as discussed above with reference to FIGS. 2 and 3. One or both of the DMA channels 316 and 318 may comprise logic to selectively process data access descriptors in the common format to initiate either a DMA transfer of a contiguous data buffer or the retrieval and processing of a scatter gather list as discussed above with reference to the DMA channel 18 in FIG. 1. Accordingly, the processor 304 may be relieved of the processing overhead of formatting multiple data access descriptors from a scatter gather list to fulfill a request from the host processing system.

While there has been illustrated and described what are presently considered to be example embodiments of the present invention, it will be understood by those skilled in the art that various other modifications may be made, and equivalents may be substituted, without departing from the true scope of embodiments of the invention. Additionally, many modifications may be made to adapt a particular situation to the teachings of embodiments of the present invention without departing from the central inventive concept described herein. Therefore, it is intended that embodiments of the present invention not be limited to the particular embodiments disclosed, but that the invention include all embodiments falling within the scope of the appended claims.

1. A method comprising:
storing a data access descriptor in a memory, said storing being performed by a core processor in an I/O (input/output) system; and
initiating a direct memory access (DMA) transaction on a DMA channel by:
retrieving the data access descriptor from the memory; and
selectively processing one or more data fields of the data access descriptor, said selectively processing based upon a control data field that indicates one of:
information identifying a memory location of a contiguous data buffer; and
information identifying a memory location of a scatter gather list, and one of multiple formats of the scatter gather list.

2. The method of claim 1, wherein the information identifying the memory location of the contiguous data buffer comprises a buffer address and a buffer size.

3. The method of claim 2, wherein the method further comprises processing one or more data fields of the data access descriptor as information identifying a destination address upon processing the one or more data fields of the data access descriptor as information identifying a memory location of a contiguous data buffer.

4. The method of claim 1, wherein said initiating a DMA transaction further comprises transmitting the contents of a contiguous data buffer at the memory location.

5. The method of claim 1, wherein the method further comprises sequentially retrieving a plurality of data access descriptors from the memory.

6. The method of claim 1, wherein said initiating a DMA transaction further comprises processing the scatter gather list.

7. The method of claim 1, wherein if the control data field indicates information identifying a memory location of a scatter gather list, the method further comprises:
retrieving the scatter gather list from the memory location; and
initiating one or more bus transactions to retrieve a plurality of non-contiguous data buffer segments identified in the retrieved scatter gather list.

8. The method of claim 7, wherein the method further comprises initiating one or more bus transactions to transfer the retrieved data buffer segments to a destination address as a contiguous data buffer.

9. The method of claim 7, wherein the method further comprises initiating one or more bus transactions to transfer the retrieved data buffer segments to a corresponding number of destination addresses.

10. The method of claim 1, wherein the information identifying one of multiple formats of the scatter gather list comprises one of:
a segment format; and
a page list format.

11. An apparatus comprising:
logic to:
store a data access descriptor in a memory, the store being performed by a core processor in an I/O (input/output) system;
initiate a direct memory access (DMA) transaction on a DMA channel by:
retrieving a data access descriptor from the memory; and
selectively processing one or more data fields of the data access descriptor, said selectively processing based upon a control data field that indicates one of:
information identifying a memory location of a contiguous data buffer; and
information identifying a memory location of a scatter gather list, and one of multiple formats of the scatter gather list.

12. The apparatus of claim 11, wherein the apparatus further comprises logic to initiate a bus transaction to retrieve data from the contiguous data buffer in response to processing the one or more data fields of the data access descriptor as information identifying a memory location of a contiguous data buffer.

13. The apparatus of claim 12, wherein the apparatus further comprises:
logic to initiate retrieval of a scatter gather list from the memory in response to processing the one or more data fields of the data access descriptor as information identifying a memory location of a scatter gather list; and
logic to initiate direct memory access transactions to retrieve data buffer segments identified in the retrieved scatter gather list.

14. The apparatus of claim 11, wherein the information identifying the memory location of the contiguous data buffer comprises a buffer address and a buffer size.

15. The apparatus of claim 14, wherein the apparatus further comprises logic to initiate a bus transaction to retrieve data from a contiguous portion of a memory at a location specified in a field of the memory access data descriptor.

16. The apparatus of claim 11, wherein the scatter gather list comprises information identifying memory locations of a plurality of data buffer segments.

17. The apparatus of claim 11, the apparatus further comprising logic to sequentially retrieve a plurality of data access descriptors from the memory.

18. The apparatus of claim 11, the apparatus further comprising logic to initiate a bus transaction between a plurality of bus agents upon processing the data access descriptor as information identifying a memory location of a contiguous data buffer.

19. The apparatus of claim 11, wherein if the control data field indicates information identifying a memory location of a scatter gather list, the apparatus further comprises:
logic to retrieve the scatter gather list from the memory location; and
logic to initiate one or more bus transactions to retrieve a plurality of data buffer segments identified in the retrieved scatter gather list.

20. The apparatus of claim 19, wherein the apparatus further comprises logic to initiate one or more bus transactions to transfer the retrieved data buffer segments to a destination address as a contiguous data buffer.

21. The apparatus of claim 19, wherein the apparatus further comprises logic to initiate one or more bus transactions to transfer the retrieved data buffer segments to a corresponding number of destination addresses.

22. The apparatus of claim 11, wherein the information identifying one of multiple formats of the scatter gather list comprises one of:
a segment format; and
a page list format.

23. A system comprising:
a host processing system; and
a peripheral device coupled to the host processing system through a data bus, the peripheral device comprising:
a core processor to receive requests from the host processing system and store data access descriptors in a storage medium in response to the requests; and
a direct memory access (DMA) channel to initiate a direct memory access (DMA) transaction, the DMA channel comprising:
logic to sequentially retrieve the data access descriptor from the storage medium; and
logic to selectively process one or more data fields of the data access descriptor, said logic based upon a control data field that indicates one of:
information identifying a memory location of a contiguous data buffer; and
information identifying a memory location of a scatter gather list, and one of multiple formats of the scatter gather list.

24. The system of claim 23, wherein the DMA channel further comprises logic to initiate a bus transaction to retrieve data from the contiguous data buffer in response to processing the one or more data fields of the data access descriptor as information identifying a memory location of a contiguous data buffer.

25. The system of claim 24, wherein if the control data field indicates information identifying a memory location of a scatter gather list, the system further comprises:
logic to initiate retrieval of the scatter gather list in response to processing the one or more data fields of the data access descriptor as information identifying a memory location of a scatter gather list; and
logic to initiate one or more bus transactions to retrieve data from data buffer segments identified in the retrieved scatter gather list.

26. The system of claim 25, wherein the apparatus further comprises logic to initiate one or more bus transactions to transfer the retrieved data buffer segments to a destination address as a contiguous data buffer.

27. The system of claim 25, wherein the apparatus further comprises logic to initiate one or more bus transactions to transfer the retrieved data buffer segments to a corresponding number of destination addresses.

28. The system of claim 23, wherein the information identifying one of multiple formats of the scatter gather list comprises one of:
a segment format; and
a page list format.

29. The system of claim 23, wherein the information identifying the memory location of the contiguous data buffer comprises a buffer address and a buffer size.

30. The system of claim 23, wherein the scatter gather list comprises information identifying memory locations of a plurality of non-contiguous data buffer segments.
